(19) United States
(12) Patent Application Publication
(10) Pub. No.: US 2004/0057224 A1
(43) Pub. Date: Mar. 25, 2004

(54) High density electronics assembly and method

(76) Inventor: Frederick J. Kiko, Carlsbad, CA (US)

Correspondence Address: GAZDZINSKI & ASSOCIATES, Suite 375, 11440 West Bernardo Court, San Diego, CA, 92127, US

(21) Appl. No.: 10/627,942

(22) Filed: Jul. 25, 2003

Related U.S. Application Data
(60) Provisional application No. 60/398,405, filed on Jul. 25, 2002.

(51) Int. Cl. H02B 1/20

(52) U.S. Cl. 361/828

(57) ABSTRACT

A high density electronics assembly which is highly modular in nature, thereby allowing a user to configure the assembly as desired for particular applications. The assembly also advantageously utilizes electronics inserts that are standardized across varying configurations, thereby obviating the need for different inserts for different applications. In one exemplary embodiment, the assembly comprises a low-profile Digital Subscriber Line (DSL) splitter apparatus, having a plurality of splitter circuits disposed within a housing structure in high density. Methods for manufacturing and configuring the assembly are also disclosed.

### PRIORITY

The present application claims priority to U.S. Provisional Patent Application Serial No. 60/398,405, entitled “HIGH DENSITY ELECTRONICS ASSEMBLY AND METHOD” filed Jul. 25, 2002, which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present invention relates generally to electronic circuit apparatus, and specifically to high-density and space-efficient modular communications assemblies and methods of manufacturing the same.

2. Description of Related Technology

A variety of different types of electronics assemblies are well known in the prior art. Factors to be considered in designing such assemblies include the methods of electrical interconnection between components, heat removal, available space and allowable “footprint”, the supply of power to the assembly, and protection from the environment. Another important design attribute is the transport of signals between the different active parts of the system with minimum loss of signal integrity. Modularity (i.e., the ability to add/remove certain components without disturbing others), scalability (the ability to readily scale the assembly in terms of size or capacity), and economy are also important features.

Traditionally, electronics assembly design was considered only after “active electronic parts” design was considered. Therefore, when the demand for smaller, denser and more customizable electronics assemblies increased, common solutions focused on decreasing the size of the actual active electronics parts (e.g., ICs, discrete electronic components, etc.), thereby allowing use of smaller parent substrates (e.g., PCBs). Although these and similar methods decreased the size of individual ICs (and hence the printed circuit boards used to support their operation), the overall volume of the electronics assembly often remained unchanged because the entire electronics assembly configuration was only considered much later in the design process.

Attempting to address this deficiency, various high-density electronics packaging approaches have been proposed. For example, U.S. Pat. No. 6,542,376 issued Apr. 1, 2003 to Watson discloses an exemplary electronics packaging system, which provides for a high density assembly of groups of similar solid state part packages. Provided is a method for interconnecting the signal paths, structurally assembling and supporting the parts, and removing heat generated within the components. The invention allowed for the modular construction of large amounts of solid state memory.

Similarly, U.S. Pat. No. 6,201,698 issued Mar. 13, 2001 to Hunter discloses a modular electronics packaging system including multiple packaging slices that are mounted horizontally to a base structure. The slices interlock to provide added structural support. Each packaging slice includes a rigid and thermally conductive housing having four side walls that together form a cavity to house an electronic circuit. The chamber is enclosed on one end by an end wall, or web, that isolates the electronic circuit from a circuit in an adjacent packaging slice. Each slice also includes a mounting bracket that connects the packaging slice to the base structure. Four guide pins protrude from the slice into four corresponding receptacles in an adjacent slice. A locking element, such as a set screw, protrudes into each receptacle and interlocks with the corresponding guide pin. A conduit is formed in the slice to allow electrical connection to the electronic circuit.

U.S. Pat. No. 4,764,846 issued Aug. 16, 1998 to Go discloses a high density electronic package in which a stack of layer-like sub-modules have their edges secured to a stack-carrying substrate, the latter being in a plane perpendicular to the planes in which the sub-modules extend. See also, U.S. Pat. No. 4,953,058 issued Aug. 28, 1990 to Harris, disclosing an electronic assembly of two planar electronic devices for insertion into a shelf for backplane connection.

Although the foregoing prior art solutions offer some degree of modularity and scalability, they are not completely optimized for certain high-density applications such as those associated with Digital Subscriber Line Access Multiplexers (DSLAMs) and related Central Office (CO) equipment. Specifically, prior art electronics shelving technology are substantially unitary with respect their backplane configuration; i.e., one large backplane mounted to a correspondingly large multi-slot frame which is adapted to permit subsequent scaling of the assembly, such as by inserting additional DSL filter modules (e.g., cards) into the frame. This is a highly cost-inefficient solution, since the service provider or other user wishing to utilize only a small number of individual modules must purchase the excess capacity (i.e., large frame and backplane) even when not needed. What would be ideal is if the service provider/user could scale the entire installation (backplane and modules) to their individual needs, thereby obviating paying for capacity they may never use. This concept is referred to subsequently herein as “complete scalability”.

Also highly desirable would be improved spatial efficiency with respect to each of the foregoing modules/cards (“density”), thereby allowing for increased space conservation within the assembly. Significant improvements in such spatial density would be leveraged in installations having many such modules, thereby allowing these larger installations to make appreciable reductions in their usage of space.

Based on the foregoing, an improved electronics assembly having (i) high-density, (ii) “complete scalability”; and (iii) modularity is needed for use in electronics applications such as for example digital subscriber line (DSL) multiplexers and CO installations. Such improved apparatus would ideally (i) allow the user to self-configure the assembly on-site by adding or subtracting modules (e.g. printed circuit boards) and the associated backplane elements as needed, (ii) be highly cost-effective to manufacture and provide a cost advantage to use, (iii) be physically compact in volume, and (iv) maintain the ability to expand to greater capacity without having to purchase an upgraded housing or frame.

### SUMMARY OF THE INVENTION

The present invention satisfies the aforementioned needs by providing an improved electronics assembly apparatus and methods for using and manufacturing the same.

In a first aspect of the invention, an improved electronics assembly is disclosed. The assembly generally comprises at least one electronics element, the at least one assembly having at least one circuit disposed thereon; and a structure adapted to receive the at least one electronics element and retain the at least one element in a substantial fixed position; the structure further comprising at least one backplane element adapted to electrically communicate with the at least one electronics element, the backplane element having a plurality of ports for electrically communication with other electronic devices; wherein the assembly is further adapted to accommodate a varying number of electronics and backplane elements according to the configuration desired by the user. In one exemplary embodiment, the assembly is used in a DSL application and capable of receiving up to four cards having a total of ninety-six (96) different DSL splitter circuits disposed thereon, the four cards being contained within a low-profile external housing. The assembly further comprises a set of four backplane elements adapted to mate with corresponding ones of the cards, thereby allowing the user complete modularity and control of the configuration.

In another exemplary embodiment, the assembly is configured without any backplane connectors for even lower cost and simplicity, such as is dictated by certain international (i.e., extra-U.S.) applications.

In a second aspect of the invention, an improved backplane element for use with the aforementioned electronics assembly is disclosed. In one exemplary embodiment, the backplane element comprises three multi-terminal connectors (for connection with DSLAM, POTS, and outside plant apparatus, respectively) and an edge connector adapted to mate with a corresponding one of the aforementioned electronic insert elements (cards). The backplane also utilizes a novel and low cost flexible circuit board and associated fabrication technique for terminating the various electrical connections between the four connectors. In the exemplary embodiment, the edge connector is further configured with bridging “make-before-break” contacts which allow the substrate to be removed without causing interruptions in the substrate (e.g., POTS) circuits.

In a third aspect of the invention, an improved electronics insert element for use with the aforementioned assembly is disclosed. In one exemplary embodiment, the insert element comprises a substrate (e.g., PCB) with the plurality of signal conditioning circuits, such as the aforementioned DSL splitters, disposed in a substantially aligned orientation on the surface(s) of the substrate such that enhanced spatial density, reduced opportunity for noise and crosstalk, and optional separability are supported. The insert elements are also made uniform across various housing structure configurations, so as to support interchangeability between assemblies. An edge connector is used in the exemplary embodiment to interface with the substrate and circuits, thereby reducing the required space needed for the termination, and reducing the cost of the insert element and assembly as a whole.

In a fourth aspect of the invention, a method of manufacturing the aforementioned assembly (and backplane and insert elements) is disclosed.

### BRIEF DESCRIPTION OF THE DRAWINGS

The features, objectives, and advantages of the invention will become more apparent from the detailed description set forth below when taken in conjunction with the drawings, wherein:

FIG. 1a is a perspective view of an assembled modular electronics assembly (without backplane elements or electronics insert elements) according to a first exemplary embodiment of the present invention.

FIG. 1b is a perspective exploded view of the assembly of FIG. 1a.

FIGS. 1c-1e are top, front, and side plan views of the assembly of FIG. 1a, respectively.

FIG. 1f is partial disassembly view of the assembly of FIG. 1a, showing the relationship of the housing components, mounting components, backplane elements, and electronics insert elements.

FIG. 1g is a front plan view of an alternate embodiment of the circuit insert elements of the invention, adapted to interlock with each other.

FIG. 1h is a detail side plan view of one exemplary embodiment of the electronic insert element guides used with the housing embodiment of FIG. 1a.

FIG. 1i is a top plan view of one alternate embodiment of circuit trace routing within the insert elements of the invention.

FIGS. 1j-1m are top, front, perspective, and side views of one exemplary embodiment of the electronics insert element(s) according to the present invention.

FIGS. 1n and 1o are front upper and rear lower perspective views, respectively, of one exemplary embodiment of the backplane element used with the assembly of the present invention.

FIG. 1p is a front perspective assembly view of the backplane element of FIGS. 1n and 1o, illustrating the components and assembly thereof.

FIGS. 1q-1s are top, front, and side plan views of the backplane element embodiment of FIGS. 1n-1p.

FIGS. 1t-1w are top, front, perspective, and side views of one exemplary embodiment of the interface assembly used within the backplane element embodiment of FIG. 1a.

FIGS. 1x-1aa are top, front, perspective, and side views, respectively, of the assembled interface assembly within the backplane element.

FIGS. 2a and 2b are perspective views illustrating single- and dual-insert element embodiments of the improved assembly of the present invention.

FIG. 3 is front perspective view of another embodiment of the assembly of the present invention, adapted for use with a Digital Subscriber Line Access Multiplexer (DSLAM) or comparable device.

FIG. 4 is a front perspective view of yet another embodiment of the assembly of the present invention, adapted for use with a low-profile Digital Subscriber Line Access Multiplexer (DSLAM) or comparable device.

FIGS. 5a and 5b are front and rear perspective views, respectively, of yet another embodiment of the assembly of the present invention, adapted to receive a plurality of electronic insert elements in vertical side-by-side orientation.

FIG. 6 is rear perspective view of another exemplary embodiment of the backplane element of the invention, having a plurality of heterogeneous connector ports in side-by-side configuration.

FIGS. 7a-7i are various views of yet another embodiment of the assembly (without backplane) and associated components of the present invention.

FIG. 8a is a partial schematic of tip/ring leads in a filter circuit, wherein unwanted capacitances exist.

FIG. 8b is a partial schematic of tip/ring leads in a filter circuit, wherein the unwanted capacitances are cancelled.

FIG. 9 is a logical flow chart illustrating one embodiment of the method of manufacturing the improved assembly and associated components of the present invention.

### DETAILED DESCRIPTION OF THE INVENTION

Reference is now made to the drawings wherein like numerals refer to like parts throughout.

It is noted that while portions of the following description is cast primarily in terms of RJ-type connectors of the type well known in the art (e.g., RJ-21), the present invention may be used in conjunction with any number of different connector types. Accordingly, the following discussion of the RJ connectors is merely exemplary of the broader concepts.

As used herein, the term “signal conditioning” or “conditioning” shall be understood to include, but not be limited to, signal voltage transformation, filtering and noise mitigation or elimination, current limiting, sampling, signal processing, splitting, and time delay.

As used herein, the term “integrated circuit” shall include any type of integrated device of any function, whether single or multiple die, or small or large scale of integration, including without limitation applications specific integrated circuits (ASICs), field programmable gate arrays (FPGAs), digital processors (e.g., DSPs, CISC microprocessors, or RISC processors), and so-called “system-on-a-chip” (SoC) devices.

As used herein, the terms “electrical component” and “electronic component” are used interchangeably and refer to components adapted to provide some electrical function, including without limitation inductive reactors (“choke coils”), transformers, filters, transistors, gapped core toroids, inductors (coupled or otherwise), capacitors, resistors, operational amplifiers, and diodes, whether discrete components or integrated circuits, whether alone or in combination.

As used herein the term “digital subscriber line” (or “DSL”) shall mean any form of DSL configuration or service, whether symmetric or otherwise, including without limitation so-called “G.lite” ADSL (e.g., compliant with ITU G.992.2), RADSL: (rate adaptive DSL), VDSL (very high bit rate DSL), SDSL (symmetric DSL), SHDSL or super-high bit-rate DSL, also known as G.shdsl (e.g., compliant with ITU Recommendation G.991.2, approved by the ITU-T February 2001), HDSL: (high data rate DSL), HDSL2: (2nd generation HDSL), and IDSL (integrated services digital network DSL), as well as In-Premises Phoneline Networks (e.g., HPN).

Electronics Assembly

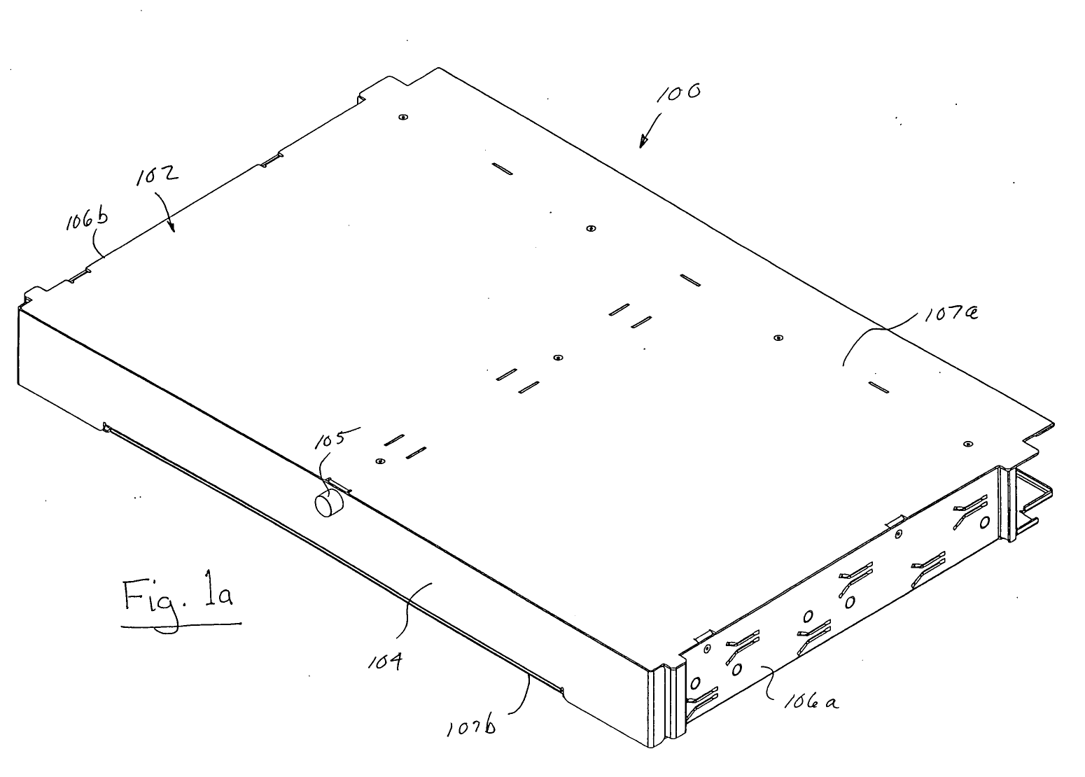

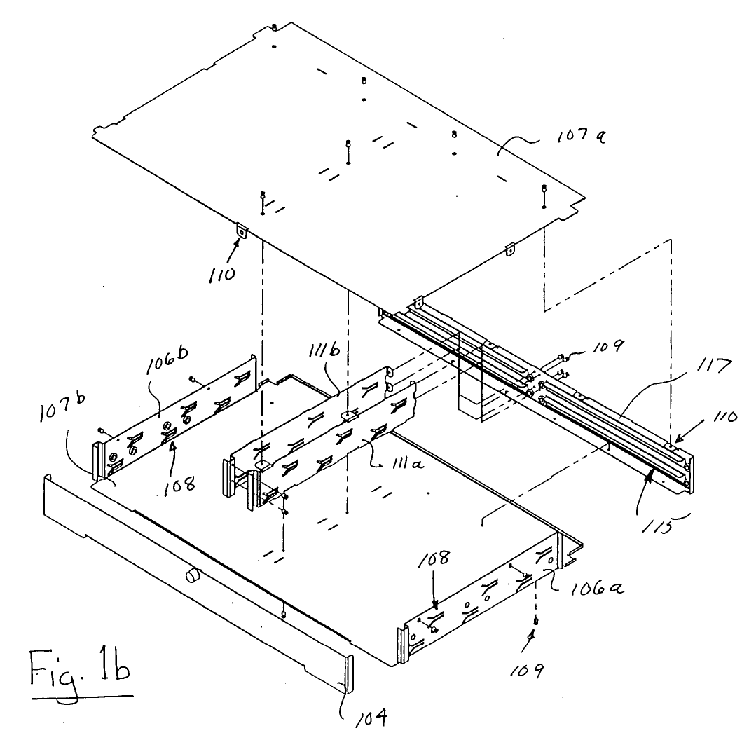

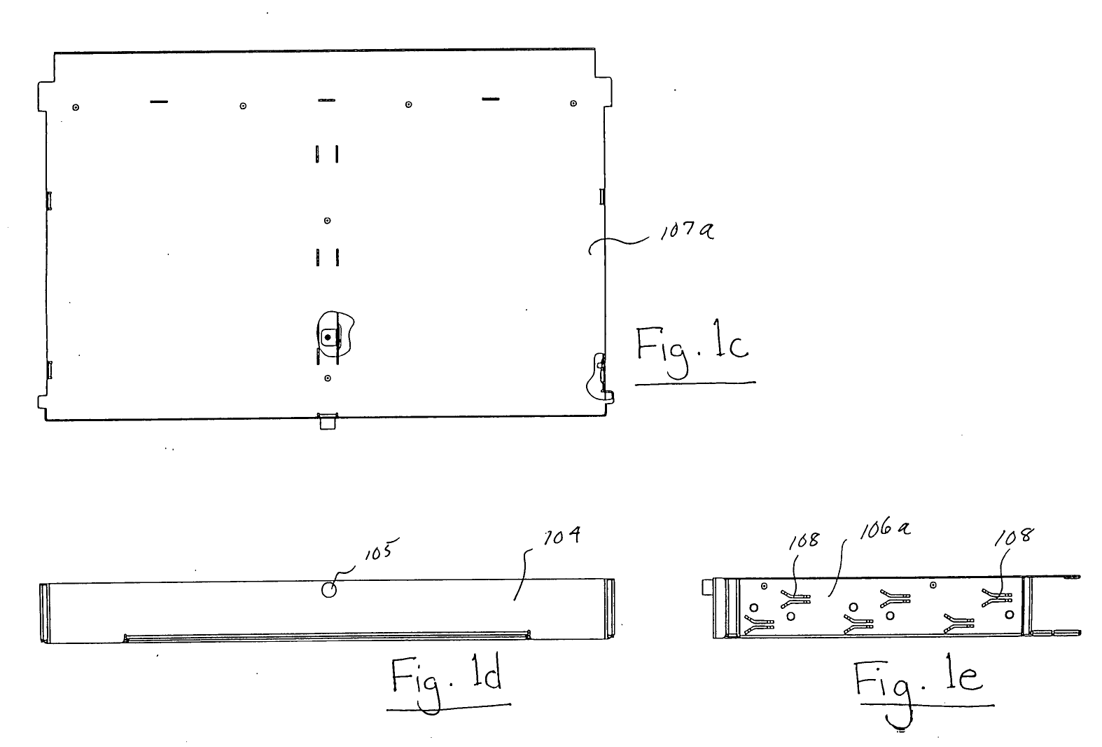

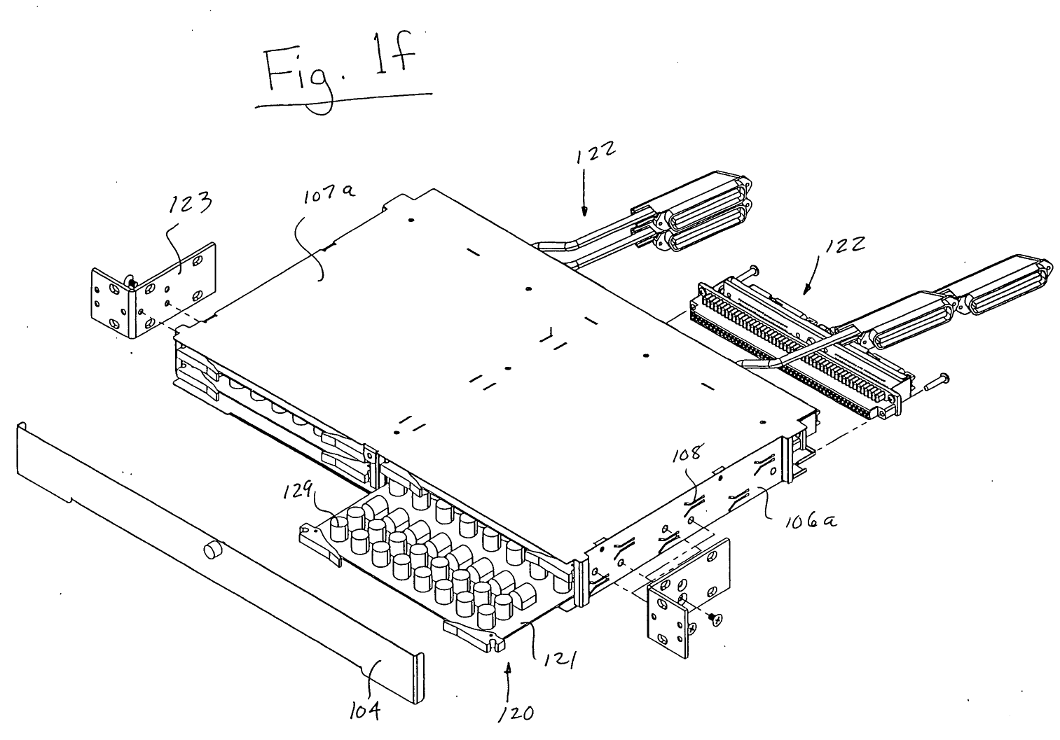

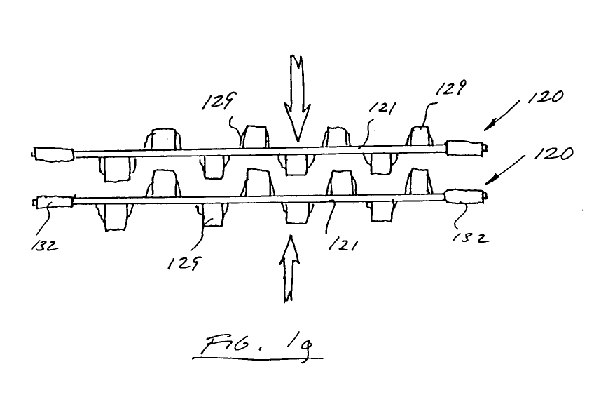

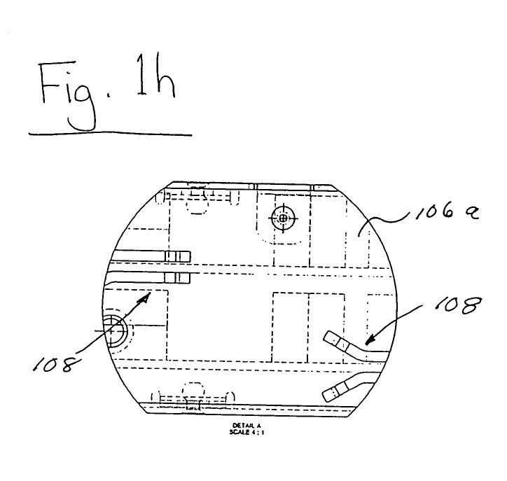

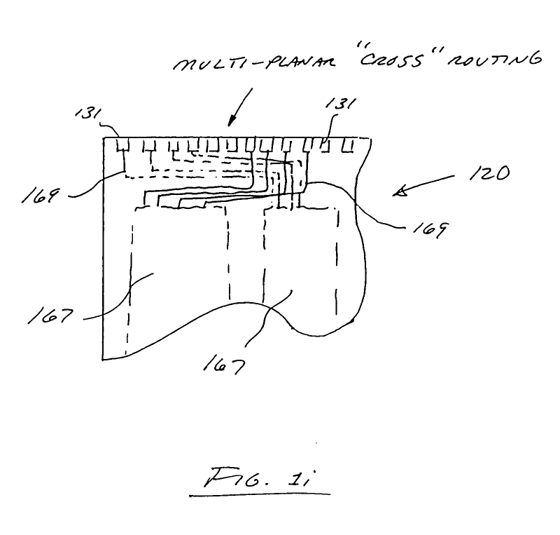

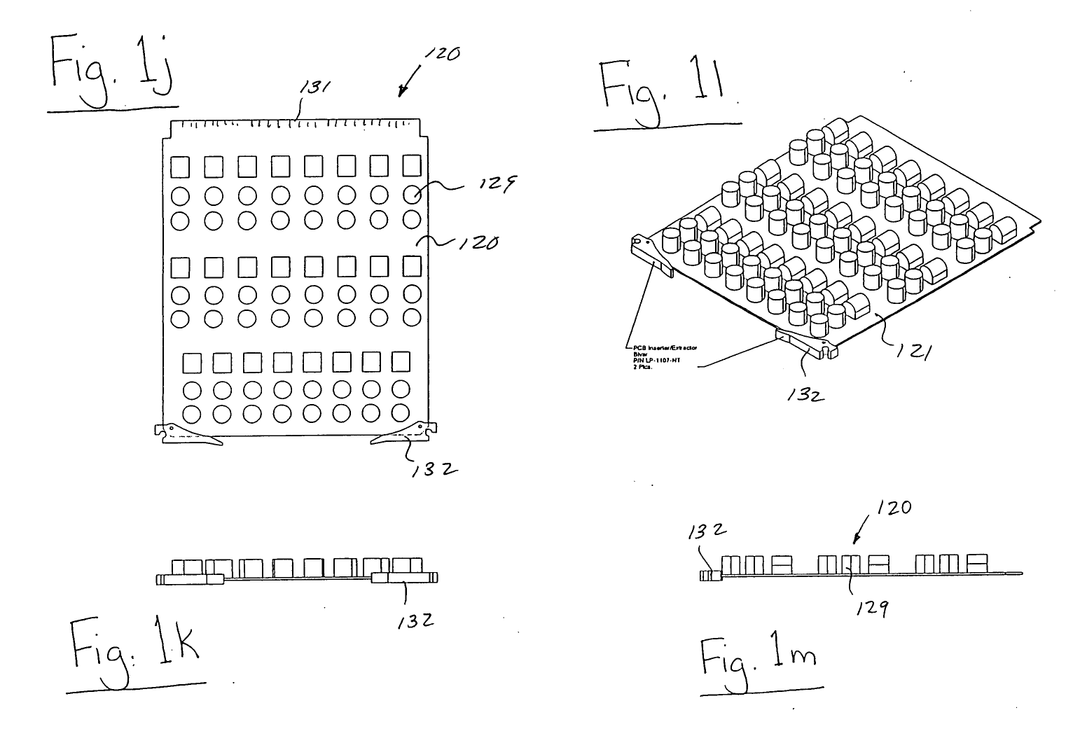

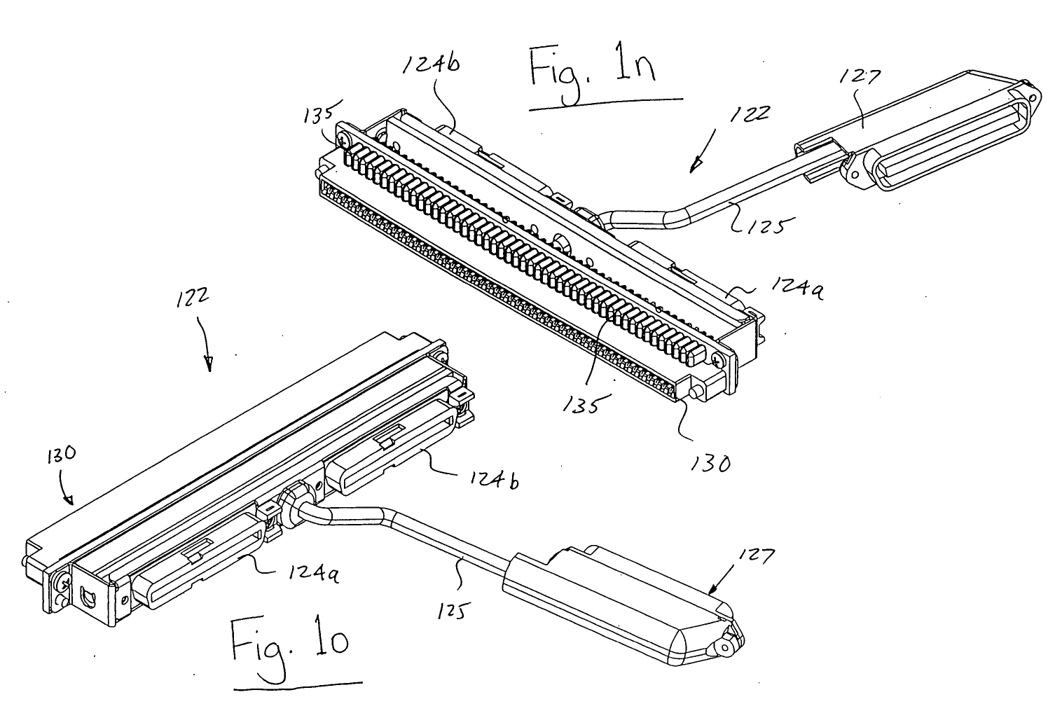

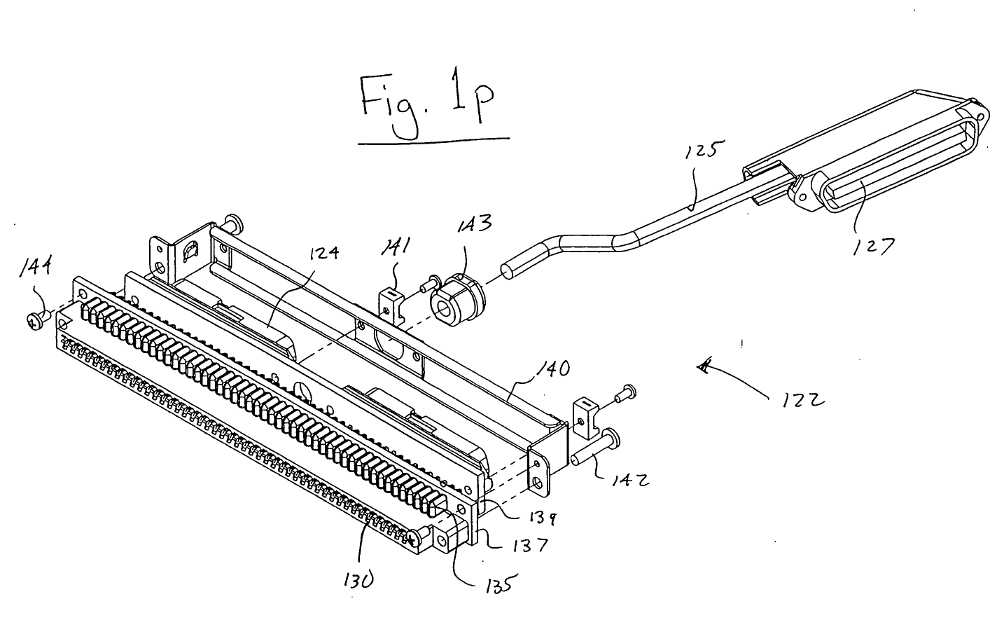

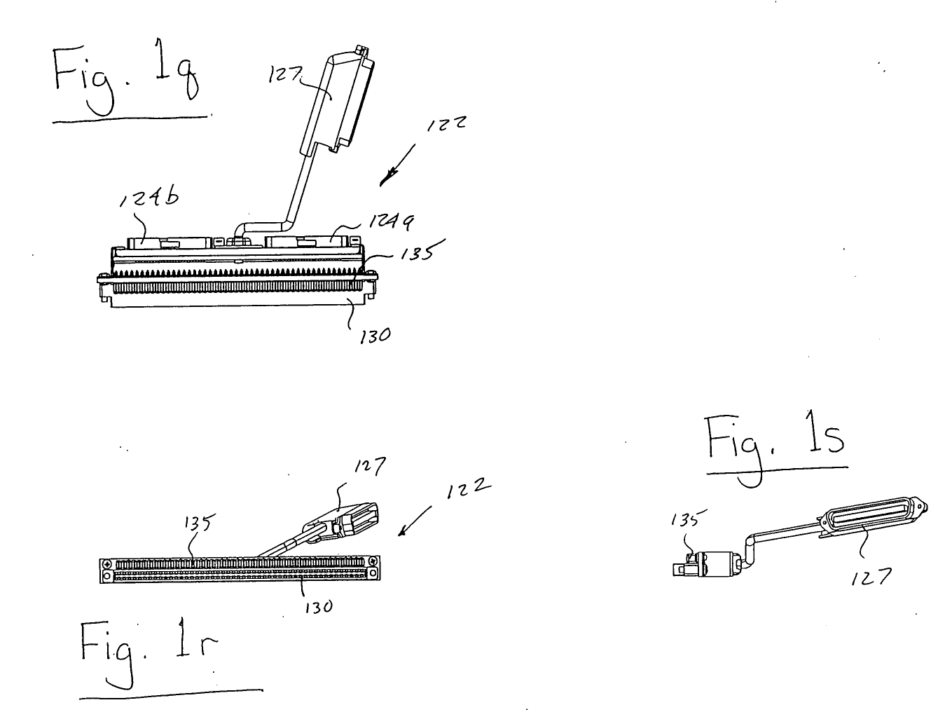

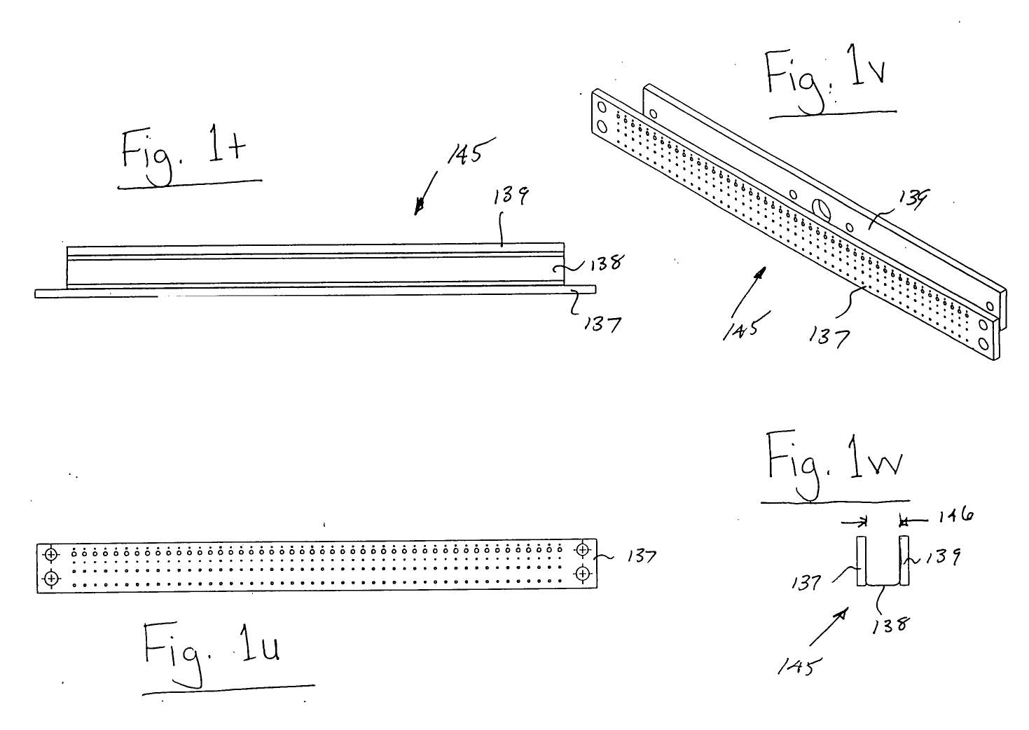

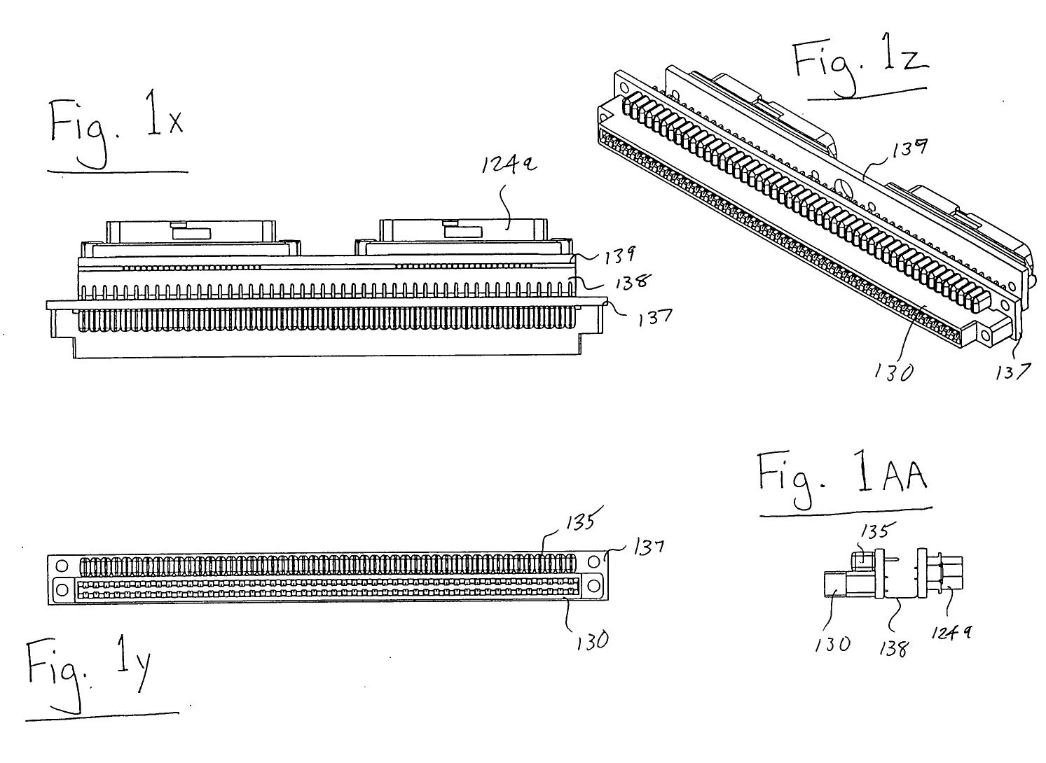

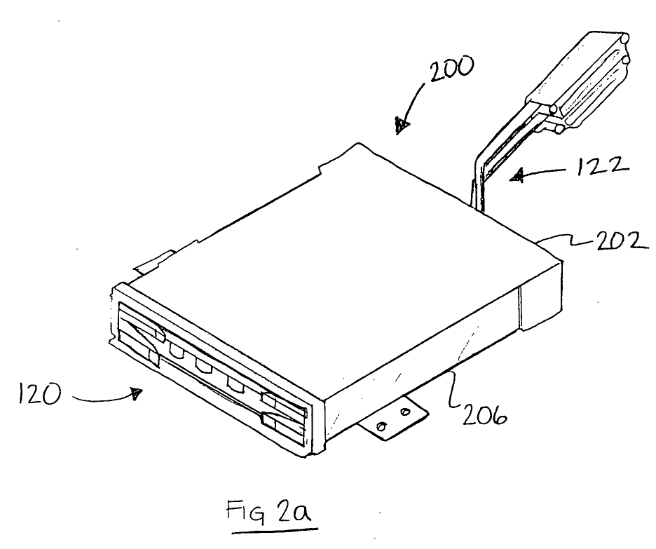

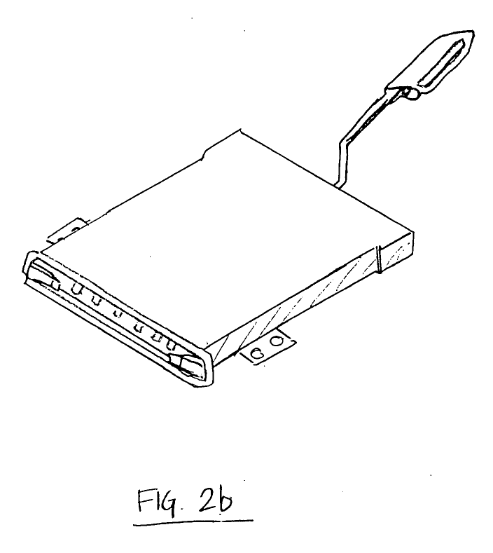

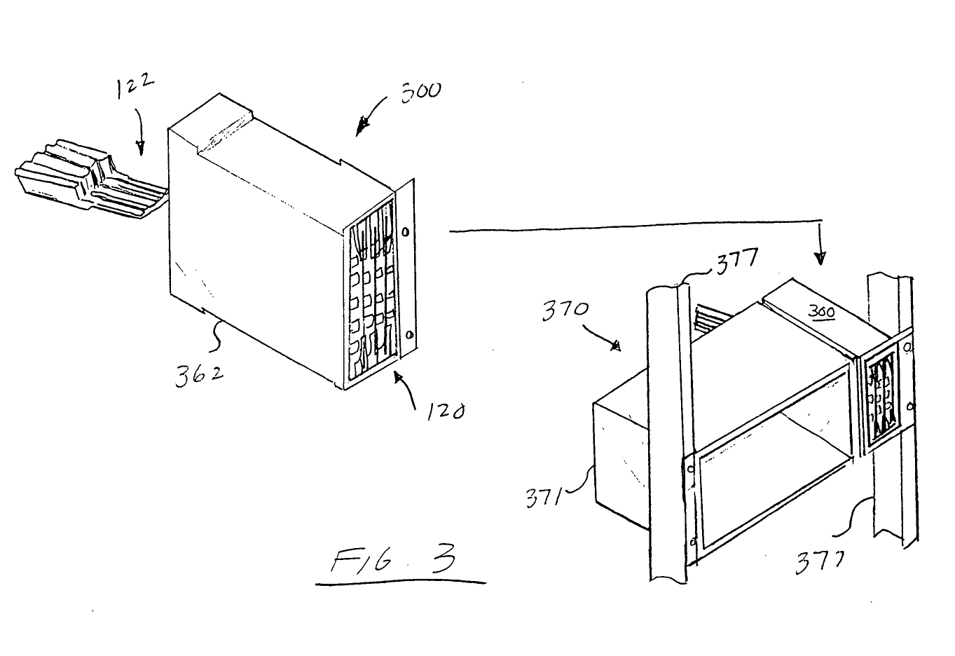

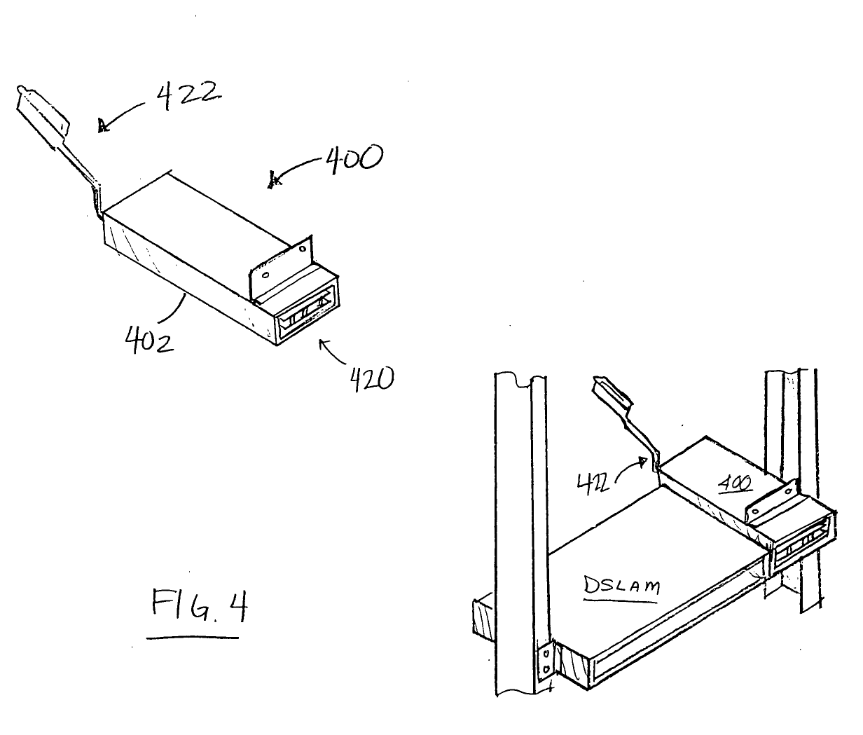

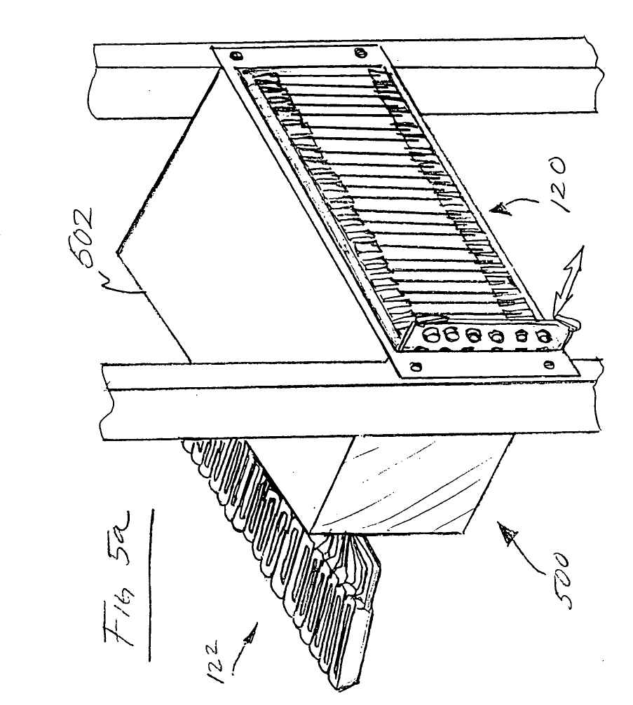

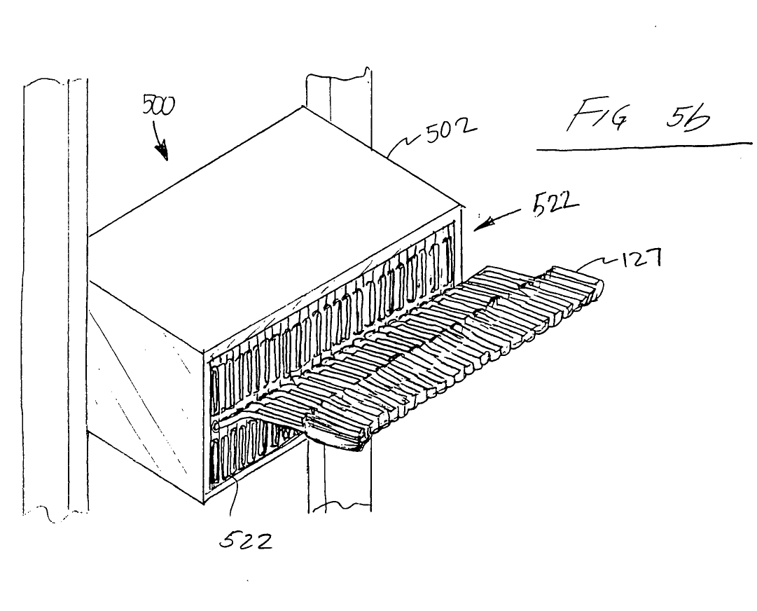

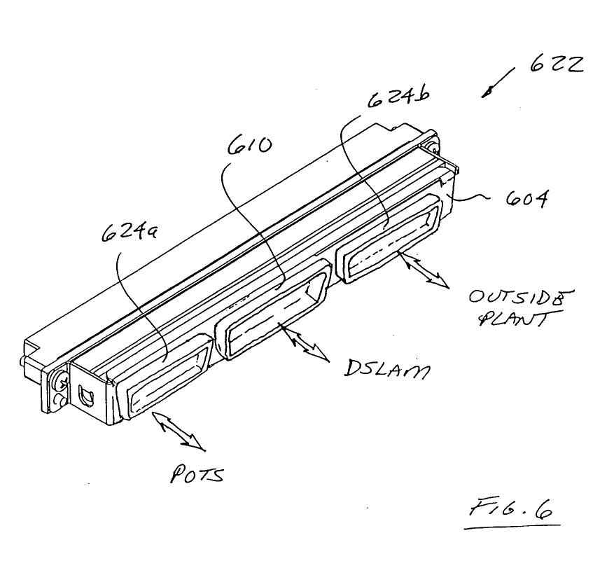

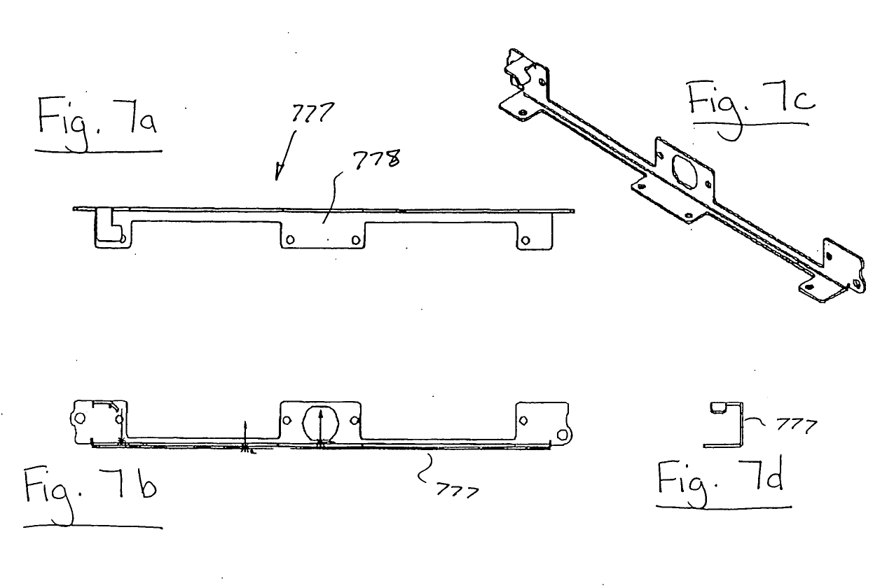

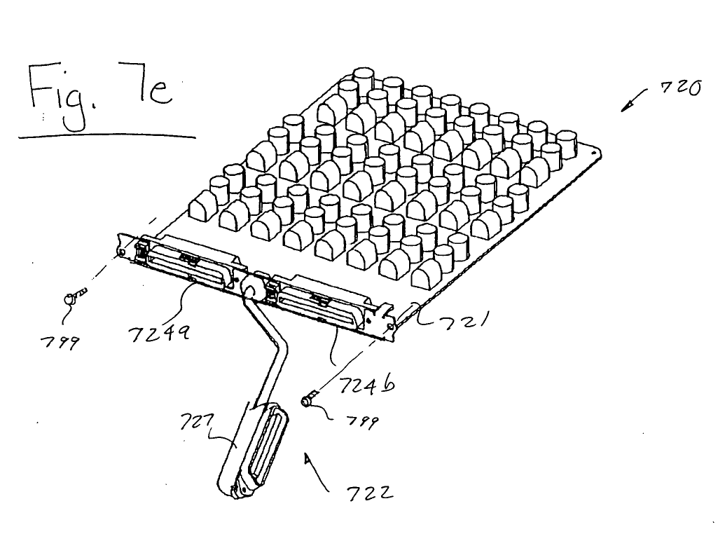

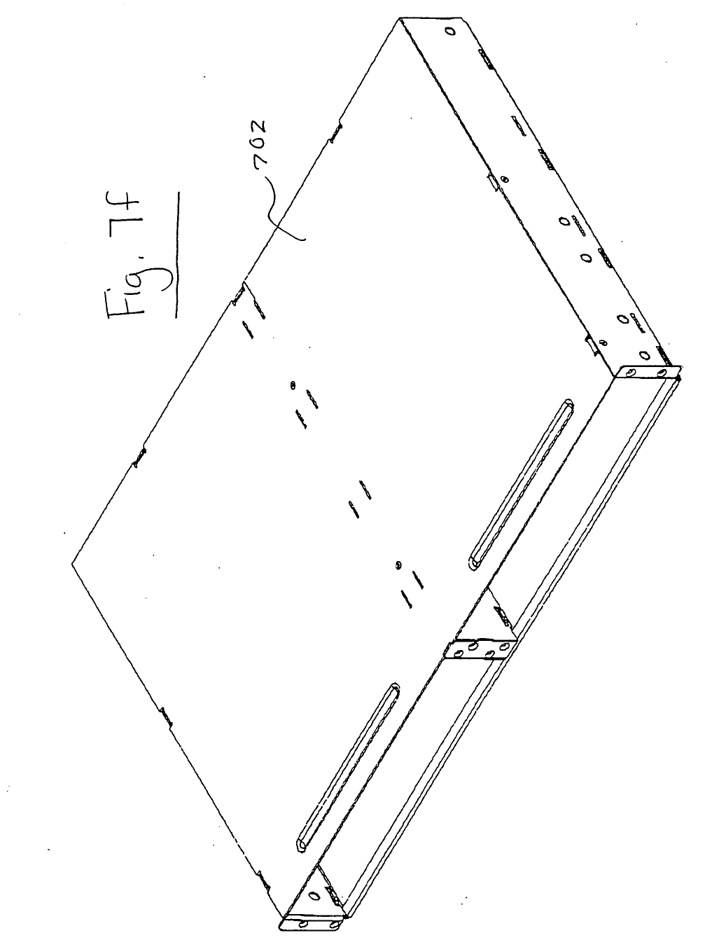

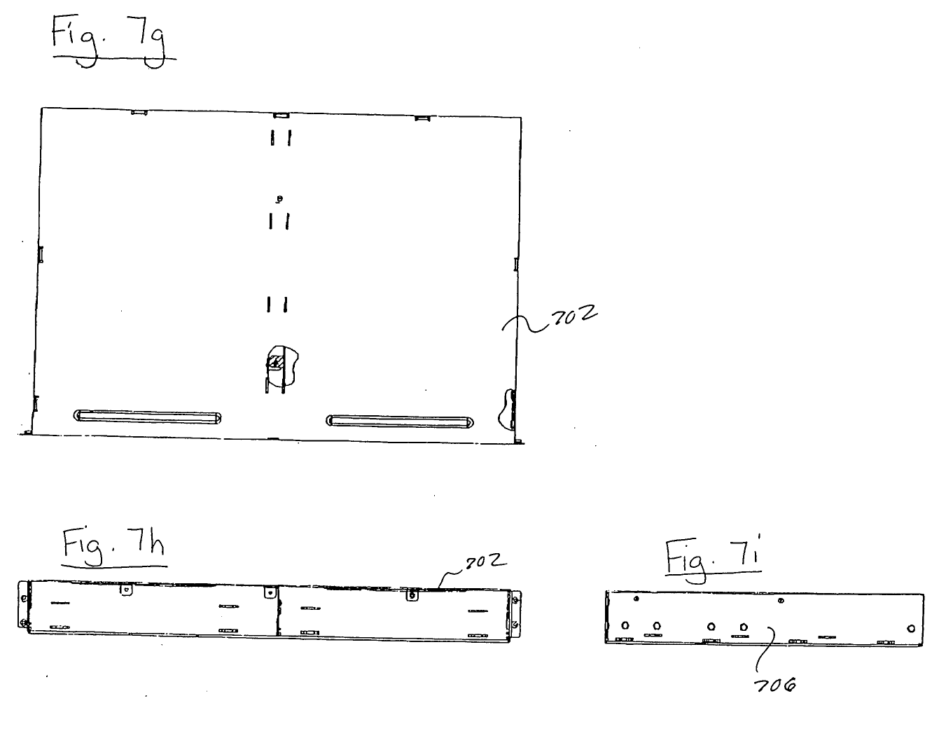

Referring now to FIGS. 1a-1aa, a first exemplary embodiment of the electronics assembly of the present invention is described. It will be recognized that while the following discussion is cast in terms of a four-insert configuration, the invention is equally applicable to other configurations, many of which are described subsequently herein. In fact, this feature underscores some of the primary benefits of the improved assembly and housing of the invention; i.e., modularity and ability to be constructed/operated in many different configurations, thereby providing the installer and operator great flexibility as well as ease of maintenance and low cost.

FIG. 1a shows a perspective view of the housing structure 102 of the assembly 100 (shown partly assembled). This outer structure 102 comprises a substantially rectangular low profile “box” with a removable face plate 104 with associated retaining device 105 (e.g., knurled nut, wing nut, or comparable), side members 106a, 106b, and top and bottom members 107a, 107b. FIGS. 1c-1e illustrate various views of the housing structure 102. As will be discussed in greater detail below, the vertical profile of the housing structure 102 can be reduced as compared to prior art solutions owing to the more efficient use of internal volume by the present invention.

FIG. 1b illustrates the housing structure 102 and components of FIG. 1a in exploded fashion. Note that in the illustrated embodiment, the housing structure components are held together using a series of fasteners 109 (e.g., pop-rivets in the present embodiment, although other fasteners such as threaded machine screws, nuts/bolts, friction pins, etc. may be substituted) which cooperate with corresponding threaded holes 110 in the various mating components. However, it will be recognized by those of ordinary skill that the housing structure components may be held together using other means, including for example “tack”, heli-arc, or other welds, or adhesives. Additionally, the housing structure 102 may be fabricated as one or more substantially unitary components if desired; e.g., such as by stamping the top and bottom members 107 and side members 106 from one continuous sheet which is then deformed and joined at its free edges to form the structure 102. Yet other well recognized techniques may clearly be used if desired.

Note also that as shown in FIG. 1b, the housing structure 102 includes a set of interior side walls 111a, 111b which partition the interior volume 112 of the housing structure 102 into effectively two side-by-side regions 113a, 113b, and provide guide elements as described in greater detail below. These two regions, in the illustrated embodiment, each accept two (2) electronics insert elements (FIGS. 1j-1m) in an over-under configuration, such that the housing structure as a whole accepts four (2) such insert elements.

A back plate 117 is also provided for the housing structure 102, the back plate 117 mating with the top and bottom members 107 when assembled as shown. The back plate 117 further includes a plurality of apertures 115 which are disposed in cooperation with the aforementioned electronic inserts such that the rearward edge of the latter can be accessed through its corresponding aperture 115 when the assembly 100 is completely assembled.

As more clearly shown in FIGS. 1b and 1h, the side and internal members 106, 111 each include a plurality of guide elements 108 which are adapted to receive and guide electronics insert elements 120 (FIGS. 1j-1m) when the latter are installed in the housing structure 102. These elements 108 frictionally engage the substrate 121 of the insert elements at their edges to a desired degree, thereby firmly holding the substrates in place, yet not impeding the movement of the substrates in and out of the housing 102. In the illustrated embodiment, three sets of guides 108 are provided for each substrate, although this number and the placement of the guides 108 can readily be varied as desired. Additionally, it will be recognized that the guides 108 can comprise other types of device. For example, in one alternate embodiment, the guides 108 comprise straight-edge raised element pairs (i.e., similar to those shown in FIG. 1b, yet without the “Y” shape). As another alternative, the guides may comprise a series of small raised pins or dowels (not shown) arranged in an array. As yet another alternative, the guides may comprise a set of depressed elongated slots (not shown) formed into the side walls 106, 111, such that effectively the entire depth of each substrate is restrained in the slots when installed. As yet another alternative, the guides may comprise mechanical fasteners which, after the substrate has been disposed in the proper orientation in the housing, are operated (e.g. turned via an external screw or operator) to frictionally engage or latch the substrate(s) in place. It will be apparent to those of even rudimentary skill in the mechanical arts that myriad different options can be used consistent with the invention for receiving, guiding, and securing the substrates into the housing as desired.

In the present embodiment, the various structural components of the housing 102 are fabricated from sheet steel (such as that commonly used to fabricate the interior frames and structures of computers) which may be galvanized or anodized to prevent corrosion, although this is not required. Alternatively, aluminum, copper, zinc, or alloyed materials, passivated or otherwise, may be used in whole or part. It is also contemplated that the housing 102 of the invention may be formed from other materials if desired including polymers, composites, or any substance with sufficient mechanical properties for the intended application.

FIG. 1f illustrates the present exemplary embodiment of the assembly 100 with electronic insert elements 120, backplane elements 122, and mounting brackets 123 installed. As will be described in greater detail subsequently herein, the electronics insert elements each comprise substrates 121 (e.g., PCBs) having, inter alia, a plurality of electronic and/or signal conditioning components disposed thereon, such elements being adapted to perform particular signal conditioning or related functions. For example, in the exemplary embodiment, the circuitry of the electronics insert elements comprises a splitter circuit adapted for splitting DSL signals, such as might be used in a central office (CO) or ISP facility. Exemplary splitter circuits are described in Applicant's U.S. Pat. Nos. 6,212,259, 6,188,750, and 6,181,777 each entitled “Impedance blocking filter circuit” and incorporated herein by reference in their entirety. Also, the circuits disclosed in co-pending and co-owned U.S. provisional application Serial No. 60/479,785 filed Jun. 18, 2003, and entitled “Universal Electronic Filter and Splitter Apparatus and Method”, as well as PCT Application PCT/US01/45568 filed Nov. 14, 2001 and entitled “High Performance Micro-Filter And Splitter Apparatus”, both incorporated herein by reference in their entirety, may be used. Similarly, the improved inductive devices described in Applicant's co-pending U.S. patent application Ser. No. 10/000,877 filed Nov. 14, 2001 and entitled “Controlled Induction Device and Method of Manufacturing”, and Ser. No. 10/381,062 filed Mar. 18, 2003 and entitled “Controlled Inductance Device and Method”, also each incorporated herein by reference in their entirety, may be utilized consistent with the present invention.

However, it will be recognized that myriad other types of circuits and/or components may be disposed on one or both faces of the substrates of the insert elements 120. For example, the circuits may comprise one or more integrated circuits such as signal processing devices (e.g., DSPs) which can be used to process and condition input signals in real time. Other uses are also possible (including for example use of inductive reactors or “choke” coils for common mode filtration, etc.), such uses being recognized by those of ordinary skill in the electronics arts.

FIGS. 1j-1m illustrate the various components of the exemplary embodiment of the insert elements 120, including the substrate 121, electronic components 129, edge terminals 131, and optional extraction devices 132. The substrate 121 comprises a printed circuit board (PCB) to which the electronic components are surface mounted (or through-hole mounted) using, for example, eutectic solder of the type well known in the electrical arts. Advantageously, the electronic components 129 of the illustrated embodiment are disposed in generally linear fashion along the length of the substrate 121 (i.e., front-to-back, or alternatively side-to side), thereby allowing (i) efficient use of substrate real estate, (ii) a ground plane, and (iii) minimizing opportunities for circuit cross-talk between individual splitter circuits. This efficient and low-noise use of PCB area allows for increased circuit density per unit of housing volume, another beneficial feature of the present invention. For example, in the configuration of FIG. 1 herein, insert elements having 24 splitter (or conditioning) circuits per element 120 are used, thereby providing 4×24=96 separate circuits within the low profile housing 102 of FIG. 1a. This is in contrast to prior art solutions, which provided two (2) cards of 24 circuits each. Hence, efficient use of space within the housing 102 of the present invention allows an effective doubling of circuit volumetric density.

Cross-talk is minimized using the foregoing “linear” circuit orientation in that a given circuit will only potentially interact with an immediately adjacent neighbor circuit. Specifically, in the exemplary embodiment, ground traces are routed between the individual circuits to mitigate cross-talk, although other approaches may be utilized (as described subsequently herein).

The exemplary substrates 121 used in the invention are also advantageously constructed to reduce cost. Specifically, the exemplary embodiment uses double-sides substrates that are not plated through, thereby reducing their manufacturing cost. A limited number of hand or machine-soldered locations are provided on the substrates 121 where electrical interconnection between the various elements disposed on either side of the substrates occurs. This approach greatly simplifies substrate manufacturing, since each substrate is in effect only provided with the degree of sophistication required to implement its required functionality, and little more.

It will be recognized that while the embodiment of FIGS. 1j-1m has components disposed primarily on one side of the substrate 121, the design may be readily adapted to have components 129 on the other or both sides of the substrate 121 if desired. Furthermore, the present invention contemplates a staggered or mixed scheme (FIG. 1g), such as where the circuits on one side of the substrate alternate with those on the other side, thereby forming a “zig-zag” pattern when viewed from the edge of the substrate. Hence, when two substrates with such pattern are disposed atop one another, the circuit components 129 from one surface of one board interlock with those on the opposing surface of the other substrate, thereby allowing for close interlocking (and maximal spatial density) without having circuits from the same board be immediately adjacent one another.

As yet another alternative embodiment of the insert elements 120 (FIG. 1i), the circuits 167 disposed on the substrate 121 can be arranged in linear fashion as described above, yet instead of their conductive traces 169 merging directly with the edge terminals 131 directly in line with the respective circuits, the conductive traces at or near the edge terminals 131 may be routed (e.g., by using vias and a multi-plane circuit board) in such fashion that a given circuit utilizes edge terminals which are not immediately proximate or in-line with the corresponding circuit.

Other circuit and component dispositions with respect to the insert elements 120 may be used consistent with the invention. The foregoing are therefore merely exemplary.

It is also noted that the present embodiment of the insert element is optionally configured to maintain continuity across the POTS terminals when the insert element 120 is removed from its slot/connector. In the exemplary embodiment, this is accomplished by configuring the edge connector with bridging “make-before-break” contacts of the type known in the electrical arts. Other approaches providing similar functionality may be substituted, however.

Referring again to FIG. 1f, the backplane elements 122 of the illustrated embodiment each comprise a connector assembly which interfaces physically with the back plate 117 of the housing 102 as previously described. Specifically, as shown best in FIGS. 1n and 1o, the backplane elements 122 comprise two multi-terminal connectors 124a, 124b disposed laterally on either side of a central connector cable 125, the cable 125 electrically mated to a “pigtail” connector 127. In the illustrated embodiment, the two lateral connectors 124 are used as a plain old telephone system (POTS) signal interface 124a and an outside plant interface 124b, with the pigtail connector 127 being used to provide electrical communication with a DSL access multiplexer (DSLAM). The connectors 124, 127 each comprise in the present embodiment RJ-21 (e.g., 50-pin, 124 circuit) connectors of the type well known in the electrical arts, although others may be substituted. The cable 125 comprises a multi-conductor twisted pair cable, although others may be substituted. Furthermore, it will be recognized that numerous alternate configurations and permutations of connector types and locations may be used. For example, if desired, the two lateral connectors 124a, 124b may be disposed to one side of the backplane element 122 (not shown), with the cable 125 disposed to the other side. Similarly, multiple pigtails 127 (e.g., three or more) can be used if desired.

As best shown in FIGS. 1n and 1p, each backplane element 122 further includes a multi-terminal connector designed to interface with the terminals of the electronics insert element 120 with which the backplane element 122 is associated. Specifically, in the illustrated embodiment, a 96-terminal edge-type electrical connector 130 is used to interface with the terminals 131 (FIG. 1j) of the insert element 120. Specifically, the edge terminals 131 wrap around the rear or engaging edge of the substrate, and come into contact with the corresponding terminals of the connector 130 when the substrate is received into the connector 130. Other types of arrangements and connectors can be substituted, however. For example, the single 96-terminal connector 130 could be replaced with a bifurcated (e.g., two) 48-terminal connectors adapted to mate with corresponding portions of the substrate edge, the latter being adapted to mate with the two separate connectors. As another alternative, a separate male or female connector device (not shown) could be mounted on the rear portion of the substrate 121, these connectors mating with corresponding female or male connectors mounted on the backplane element 122. Yet other alternatives are possible and readily implemented by those of ordinary skill. The primary advantage of the illustrated embodiment over such alternatives is, however, simplicity and low cost.

The backplane element 122 further includes a plurality of optional capacitive elements 135 (e.g., discrete metallized polyester capacitors in the present embodiment) which are disposed along the upper portion of the backplane element 122 as shown in FIGS. 1n and 1x-1aa. These capacitive elements (48 in the illustrated embodiment) are utilized to provide the high-pass filter function to the DSLAM cable. This arrangement also provides advantages in terms of spatial density, since the capacitive elements 135 are disposed in a highly efficient manner on the backplane in what would otherwise be unused space, thereby obviating their placement on the insert element.

As shown in FIG. 1p, the backplane assembly 122 is comprised in the present embodiment of a connector element 130, first substrate 137, second substrate 139, secondary (e.g., POTS/outside plant) connectors 124, cable 125, and mounting hardware components 140-144. FIGS. 1q-1s illustrate the exemplary backplane element 122 fully assembled.

Additionally, as best shown in FIG. 1w, the backplane assembly includes an electrical interface 145 disposed between the first and second substrates 137, 139. The first substrate 137 is perforated with a plurality of apertures (FIGS. 1u and 1v) which accommodate respective ones of the terminals associated with the backplane connector 130 and associated capacitive elements 135, which are each mounted to the first substrate 137. Similarly, the lateral or secondary connectors 124 and pigtail connector 127 are mounted to the second substrate 139. The mounting bracket 140 for the lateral connectors 124 maintains the physical spacing between the two boards 137, 139, since the standoff height of the bracket 140 is such that a significant gap 146 is created between the opposing faces of the substrates 137, 139. Rigid spacers (not shown) can also be used (either together or in the alternative) to provide and maintain spacing of the substrates 137, 139 if desired. The interface 145 in essence “bridges the gap” between the two substrates 137, 139, and particularly the terminations of the electrical components mounted to each. Hence, the terminals associated with the backplane connector 130 are terminated to the interface 145, as are the terminals (and leads) associated with the lateral connectors 124 and pigtail 127, the two sets of terminations being in electrical communication via conductive traces (not shown) disposed on the interface 145. In the present embodiment, the interface 145 comprises a flexible sheet 138 or PC board (e.g., flexible PCB) having conductive traces disposed along its surfaces and propagating between corresponding termination points for the two substrates 137, 139. This approach, described in detail in Applicant's co-pending U.S. Provisional patent application Serial No. 60/398,403 entitled “Flexible substrate apparatus and method” and filed Jul. 25, 2002, and its corresponding utility application Ser. No. 10/______ of the same title filed contemporaneously herewith, both incorporated by reference herein in their entirety, has the advantage of low cost and ease of manufacturing, especially since flexible board 145 need undergo a very limited number of flexural cycles during manufacture (and the lifetime of the device). This type of interface also provides benefit of allowing some degree of thermal expansion/contraction of the interface components (and particularly the flexible substrate) without affecting electrical performance or requiring periodic tightening or maintenance of physical joints. Note that other approaches may be substituted, however, including use of a prefabricated flexible PCB, ribbon cable, or even direct routing of individual conductors, although clearly advantages exist for the exemplary methods described herein. FIG. 1aa illustrates the present embodiment of the interface element 145 fully assembled.

It will also be recognized that while not explicitly shown, all or portions of the electronics assembly of the present invention can be shielded against noise and electromagnetic interference if desired. Myriad shielding techniques (e.g., tin plating, etc.) are well known to those of ordinary skill in the electronics arts, and accordingly may be readily implemented consistent with the present invention.

Exemplary Alternate Embodiments

Referring now to FIGS. 2a and 2b, first and second alternate embodiments of the electronics assembly of the present invention are described.

As shown in FIG. 2a, the assembly 200 comprises a substantially “box-like” housing 202 with top, bottom, and side walls 206, and two (2) insert elements 120 and two (2) corresponding backplane elements 122 with, inter alia, pigtail connectors 127. This embodiment of the assembly 200 may be wall or shelf mounted (or even mounted in other orientations), and is adapted to provide 48 circuits or channels based on 24 channels per insert 120. Advantageously, these inserts 120 may be made identical to those previously described with respect to FIG. 1, thereby allowing the user to stock one type of replacement element 120 which will fit in multiple different assembly configurations. Similarly, the assembly 200 of FIG. 2a utilizes backplane elements 122 identical to those of the embodiment of FIG. 1.

Referring now to FIG. 2b, a related embodiment of the invention is illustrated. In this embodiment, the assembly 250 is largely identical to that of FIG. 2a, yet is adapted to receive only one (1) insert element 120 and backplane 122, both of which may again be “standard” configurations allowing for interchange between multiple different assembly configurations. This assembly 250 has the advantage of providing an ultra-low profile and light weight, thereby allowing it to be mounted almost anywhere.

Referring now to FIG. 3, a third alternate embodiment of the electronics assembly of the invention is described in detail. As shown in FIG. 3, the assembly 300 comprises a housing 302 which is adapted to mate with a corresponding DSLAM 370 or similar parent device. Specifically, in the present embodiment, the assembly housing 302 fits immediately next to the DSLAM (5U) housing 371 and is adapted to form a generally unitary device 301 which mates with an existing rack structure 377. The assembly 300 includes four identical insert elements 120 and backplane elements 122 disposed in a substantially vertical orientation within the housing 302. Each insert element is again the “standardized” configuration (e.g., 24 circuits, although others may be used), thereby providing 96 circuits in total for the assembly 300. The assembly housing 302 may be mated to the DSLAM housing 371 using any number of techniques (including adhesives, welding, fasteners, clips), or need not be fastened at all if desired, such as when the housings 302, 371 are supported by a shelf or comparable arrangement (not shown).

Referring to FIG. 4, yet another alternate embodiment of the invention is disclosed. As shown in FIG. 4, the assembly 400 comprises a “daughter” device coupled to the parent 470 in similar fashion to the embodiment of FIG. 3. However, in the apparatus of FIG. 4, the assembly 400 includes a half-width housing 402 which is adapted to receive corresponding half-width inserts 420 and half-width backplanes 422. Each half-width insert 420 comprises 12 channels, thereby providing a total of 24 channels for the assembly 400. Such assembly 400 is useful, for example with a 19″ width DSLAM (1U), the devices collectively providing an effective width of 23″ in the illustrated embodiment to make with an industry standard (“Bell Standard”) rack system. However, it will be recognized that other widths may be used. For example, the insert elements 420 can be made one-third or one-fourth width if desired, and the housing 402 adapted accordingly. Herein lies yet another significant benefit of the present invention relating to the linear disposition of circuits on the insert element substrates 121 as previously described; i.e., that the linear disposition allows the substrates to be efficiently divided if desired to produce fractional widths. Contrast prior art solutions with more amalgamated disposition of circuit elements on their substrates, wherein no clean division of individual circuits is possible.

Along these lines, the present invention also contemplates the manufacture and provision of insert substrates 121 which are scored or otherwise adapted for separation along their length in one or more lateral locations, such that the user/purchaser can reduce a “full” (e.g., 24 circuit) board to some lesser number by breaking the scored substrate along an appropriate line. For example, where the user has the assembly of FIG. 4 which needs a “half” card or insert, and the user has only a full card, he/she can simply snap the full card in half to make the needed part(s). It will be recognized that consistent with this functionality, the conductive traces on the substrates 121 can be configured so as to not cross over the scoring lines, thereby assuring continued electrical integrity after separating of the substrate 121.

Referring now to FIGS. 5a and 5b, yet another embodiment of the electronics assembly of the invention is disclosed. In this embodiment, the housing 502 is adapted to receive a plurality of vertically oriented “standard” inserts 120 (e.g., 23 inserts for a 19″ width rack, or 28 inserts for a 23″ width rack). This embodiment advantageously provides ultra-high capacity and volumetric circuit density, in that the 23 card variant provides 552 separate circuits or channels, and the 28 card variant 672 discrete channels, all within a very limited volume.

Referring now to FIG. 6, an alternate embodiment of the backplane element is illustrated. In this embodiment, the pigtail 127 of the backplane element 122 of FIG. 1 is replaced with a third connector port 610 disposed on the rear face 604 of the backplane 622, such that three connectors 624a, 624b, and 610 are disposed on the rear face 604. This embodiment is useful, inter alia, where space at the rear of the assembly is extremely limited, and/or the user does not wish to have a large number of hanging cables with pigtails connectors (such as the 28 card embodiment of FIG. 5). In the embodiment of FIG. 6, three (3) RJ-type jacks are used, although it will be recognized that other types and locations of connectors (in any number of permuted combinations) can be used as desired. For example, three high density 2 mm pin connectors could be used, although at greater cost. Hence, the embodiment of FIG. 6 is merely exemplary of these myriad other possible configurations.

It will be recognized from the foregoing descriptions of the devices of FIGS. 1-6 that one inherent benefit of the present invention is modularity and user configurability. Specifically, the present invention advantageously allows the user/operator to self-configure the assembly on-site by simply adding or subtracting insert elements 120 and associated modular backplane elements 122 as needed. This feature also provides an inherent cost advantage over prior art solutions, in that the user need not buy more capacity from the manufacturer than they need at any given time. Stated differently, the electronics assembly of the present invention can be sold as simply the housing 102 with a unitary insert card 120 and backplane 122, to which the customer can add at their own discretion additional insert/backplane elements. This reduces the minimum cost that a user must pay for a single insert/backplane-equipped device while still maintaining the ability to expand to greater capacity (up to 28 cards or more in the case of the embodiment of FIG. 6) without having to purchase an upgraded housing. Contrast prior art shelving/housing arrangements, which are comparatively expensive in their “minimum” configuration (owing largely to the lack of the modularity of the present invention), and which cannot be readily configured by the user across such a wide range of capacities.

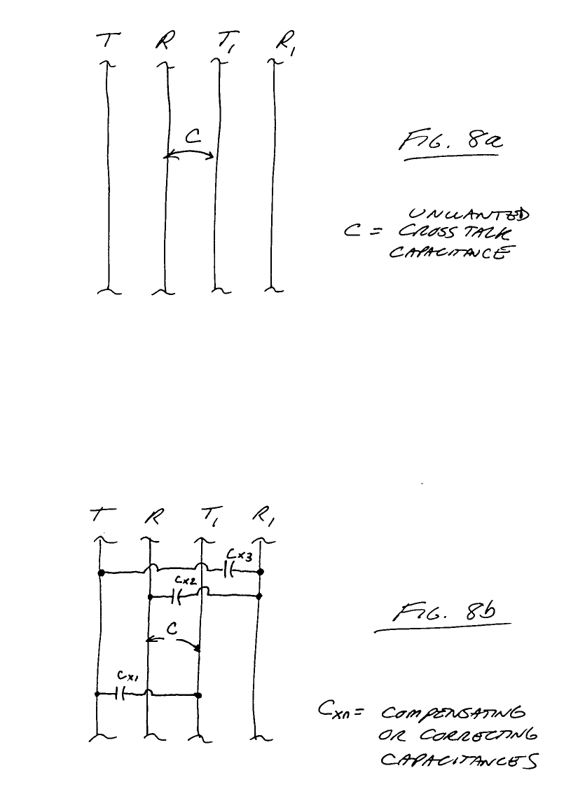

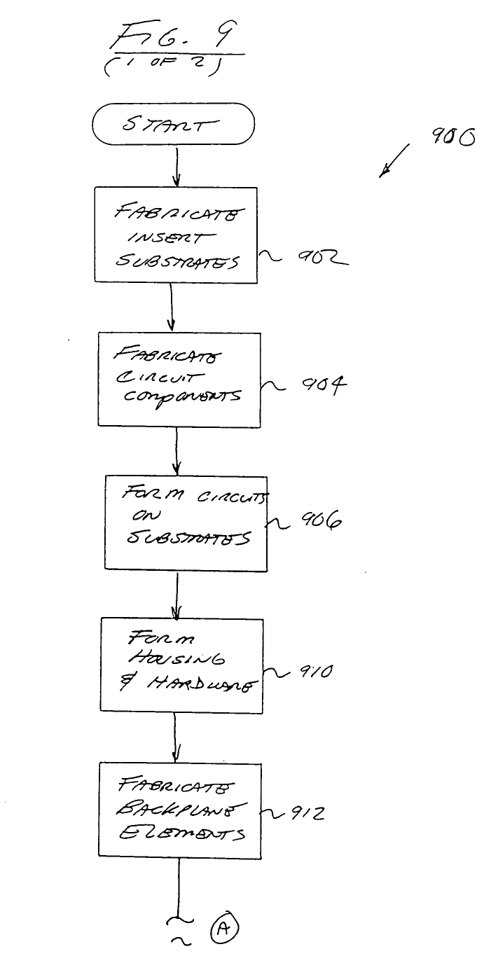

Referring now to FIGS. 7a-7i, yet another embodiment of the electronics assembly of the invention is described. This embodiment is particularly suited for, inter alia, international (i.e., extra-U.S.) applications of DSL splitter and related circuitry. This embodiment obviates the need for the backplane or flexible substrate arrangement previously described with respect to prior embodiments.

As shown in FIGS. 7a-7d, the assembly comprises a mounting bracket 777 which is attached to the substrate 721 as well as lateral (e.g., RJ-21) and pigtail connectors 724a, 724b, 727 thereon, as best illustrated in FIG. 7e. The bracket 777 comprises a metallic frame 778 shaped and deformed such that both the substrate 721 and connectors 724, 727 are rigidly mated thereto. Hence, the bracket 777, substrate, and connectors form a substantially rigid unitary assembly which is received within an assembly housing 702 shown in FIGS. 7f-7i. The end holes of the bracket 777 are configured with captive screws 799 of the type well known in the art which are received into the housing 702.

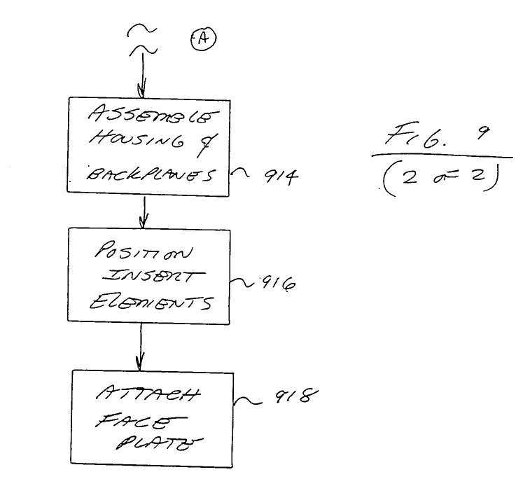

In addition to the foregoing embodiments, the present invention advantageously provides improvements adapted for the cancellation of so-called “cross-talk” and associated capacitances. Specifically, it has been observed that the RJ-21 (or similar) connectors used in the above-described embodiments, as well as other components (such as the associated “pigtail” cable may) induce cross-talk within the circuits. Even portions of the circuits (e.g., DSL filters) themselves may produce cross-talk, as previously described. FIG. 8a is a simplified illustration of exemplary tip/ring leads wherein cross-talk capacitance(s) exist.

In order to mitigate this deleterious phenomenon, the present invention utilizes one or more techniques aimed at canceling the cross-talk, including its capacitance. Generally, this approach comprises disposing a plurality of line-side capacitances within the circuit(s), as graphically illustrated in FIG. 8b. In one exemplary embodiment, a plurality of small surface mount capacitors (not shown) can be disposed on the line-side of the circuit(s) in order to cancel the cross-talk. Similarly, the PCB or substrate 121 upon which the circuits are disposed can be fabricated such that one or more traces on the PCB provide the desired capacitance values, such fabrication techniques being well known in the electrical arts. As yet another alternative, the capacitors can be disposed within the connector (or cabling) itself. Additionally, certain selected ones of the circuit traces on the substrate 121 may be reversed as is well known in the art in order to mitigate cross-talk/capacitances.

Method of Manufacture

Referring now to FIG. 9, a method 900 for manufacturing the electronics assembly 100 of the invention is illustrated in logical flow diagram form.

It will be recognized that while the following description is cast in terms of a four-card (insert) device such as that of FIG. 1, the method is generally applicable to the various other configurations and embodiments of assemblies disclosed herein with proper adaptation, such adaptation being within the possession of those of ordinary skill.

In a first step 902 of the method 900, a plurality of circuit card or similar substrates are manufactured. These substrates are perforated or otherwise adapted to receive the electrical components 129 in the linear circuit orientation (or other desired orientation) previously described herein, and further include the required number of conductive traces, edge terminals 131, and other features required by the design. Optionally, the substrates may be scored or prepared for easy fragmentation as previously described if desired. Circuit board manufacturing techniques are well known in the art, and accordingly not described further herein.

Next, in step 904, a plurality of the different types of circuit components 129 are manufactured or otherwise obtained.

In step 906, these components are disposed on the substrates in the desired orientation, and then bonded/electrically terminated to the substrate using, for example, a wave solder process. The components may also be encapsulated using, for example, a silicone-based encapsulant or similar if desired.

Next, in step 910, the housing 102 and associated hardware is formed as previously described. This formation process may comprise forming a plurality of individual components as in FIG. 1b, formation of a lesser number of components (e.g., forming the outer housing element from a single sheet), or even molding of the housing or certain components as a substantially unitary component. The fabrication and assembly of the housing each employ well known techniques which are not described further herein.

Per step 912, the backplane element components are next fabricated and assembled. These components comprise, inter alia, the pigtail cable 125 and connector 127, edge connector 130, mounting hardware 140-144, lateral connectors 124a, 124b, first and second substrates 137, 139, and interface element 145. Fabrication of these components is well understood and not described further herein, with the exception of the interface assembly 145. Specifically, the interface assembly 145 if formed using the process described in Applicant's co-owned and co-pending U.S. patent applications previously discussed and incorporated herein. This process generally involves forming the flexible portion of the interface 145 by use of scored first and second subtrates 137, 139, which is less costly and comparatively simple than using traditional flex-board fabrication technology.

Once the backplane elements 122 are formed and assembled, they are mated to the housing rear face plate 117 per step 914 using appropriate fasteners or techniques.

Next, the insert elements 122 are disposed within the guide elements 108 inside the housing 102, and slid into position such that their edge terminals 131 are received within and electrically mated with those of the edge connector 130 (step 916). Alternatively, these insert elements 122 may be disposed within the guides 108 by the customer/end user in the field (such as during initial installation, upgrade, or maintenance), as previously discussed.

Lastly, in step 918, the face plate 104 is mounted to the housing 102, and the fastener 105 actuated to secure the components 102, 104 together. The assembly can then be electrically tested if desired before installation in the desired end-application.

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. For example, while the invention has been disclosed in terms of a component for telecommunications and networking applications, the inductive device architecture of the present invention could be used in other applications such as specialized power transformers. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. An electronics assembly comprising:
at least one electronics element, said at least one element having at least one circuit disposed thereon; and
a structure adapted to receive said at least one electronics element and retain said at least one element in a substantially fixed position;
said structure further comprising at least one backplane element adapted to electrically communicate with said at least one electronics element, said backplane element having a plurality of ports for electrically communication with other electronic devices;
wherein said assembly is further adapted to accommodate a varying number of said electronics elements and respective ones of said backplane elements according to the configuration desired by the user.

2. The assembly of claim 1, wherein said plurality of ports comprises at least one pigtail connector.

3. The assembly of claim 1, wherein said one electronics element comprises a substrate having at least one circuit disposed nonlinearly on opposing sides.

4. The assembly of claim 1, wherein said assembly is used in a DSL system, and said backplane element comprises:
a first port adapted to interface electrically with a POTS entity; and
a second port adapted to electrically interface with a DSLAM.

5. The assembly of claim 1, wherein said one electronics element is configured to substantially separate a plurality of electrical circuits disposed thereon.

6. The assembly of claim 1, wherein said at least one circuit comprises one or more DSL splitter circuits.

7. An electronic insert element, comprising:
a substrate having a plurality of traces; and
a plurality of electronic components, said components adapted for mounting on said substrate, respective ones of said components forming substantially individual circuits disposed in generally linear fashion on said substrate.

8. The insert element of claim 8, further comprising a plurality of edge terminals disposed proximate at least one edge of said substrate, said terminals adapted for electrical interconnection with a corresponding connector.

9. The insert element of claim 8, further comprising ground traces routed between at least a portion of said circuits.

10. The insert element of claim 8, wherein said components are mounted opposing sides of said substrate.

11. The insert element of claim 10, wherein components associated with said circuits on the first side of said substrate are disposed in staggered fashion relative to the components of circuits disposed on the second side of said substrate.

12. The insert element of claim 8, wherein conductive traces proximate said edge terminals are adapted for routing such that individual ones of said circuits may utilizes ones of said edge terminals not immediately proximate thereto.

13. The insert element of claim 8, further comprising a plurality of capacitance-producing elements adapted to substantially cancel cross-talk associated with said circuits.

14. A structure for use with an electronics assembly, comprising:
at least one electronics element, said at least one element having at least one circuit disposed thereon;
at least one multi-terminal connector; and
an edge connector adapted to mate with said electronics element; said edge connector further adapted for removal of said electronics element the substrate without causing interruption in said circuit.

15. A backplane element, comprising:
a first multi-terminal connector disposed substantially juxtaposed to a second multi-terminal connector;
a connector cable, said cable electrically mated to a pigtail connector;
a third multi-terminal connector adapted to interface with terminals of an electronics insert element associated with said backplane element; and
an interface element disposed electrically between said third connector and said first, second, and pigtail connectors.

16. The backplane element of claim 15, wherein:
said first multi-terminal connector is adapted for use as a plain old telephone system (POTS) signal interface;
said second multi-terminal connectors is adapted for use as an outside plant interface; and
said pigtail connector is adapted to provide electrical communication with a DSL access multiplexer (DSLAM).

17. The backplane element of claim 15, further comprising a plurality of capacitive elements disposed proximate said backplane element, said capacitive elements adapted to provide the high-pass filter functionality.

18. The backplane element of claim 17, wherein said interface element comprises a substantially flexible substrate having a plurality of electrical traces formed thereon.

19. A backplane assembly, comprising:
a first electrical connector;
a first substrate adapted to receive at least part of said first connector;
a plurality of second electrical connectors;
a second substrate adapted to receive at least a portion of each of said second connectors;
structure components maintaining said first and second substrates in substantially fixed relationship; and
an electrical interface disposed substantially between said first and second substrates;
wherein said electrical interface provides electrical connection between said first connector and at least a portion of said second connectors.

20. The backplane assembly of claim 19, wherein said electrical interface comprises a flexible substrate having conductive traces disposed along its surfaces and propagating between corresponding termination points for said first and second substrates.

21. An electronics element adapted for use in a plurality of different housing configurations, comprising:
a substrate having a plurality of signal conditioning circuits, said circuits disposed in a substantially aligned orientation on at least one surface of said substrate, said alignment adapted to permit separation of said substrate into a plurality of individual substrates;
wherein said element or said individual substrates are adapted for use in various housing structure configurations.

22. The element of claim 21, wherein said electronics element further comprises a plurality of edge terminals adapted to interface with said substrate and said circuits, said edge terminals being associated with respective ones of said circuits and for separation.

23. A high-density electronics assembly housing structure, comprising:
a housing;
a face plate removably coupled to said housing;
a back plate adapted to mate to said housing, said back plate comprising a plurality of apertures; and
a plurality of guide elements adapted to receive and guide electronics insert elements, said guide elements adapted to frictionally engage the substrate of the insert elements;
wherein said guide elements are disposed in substantially proximate locations to facilitate high-density storage of a plurality of said insert elements; and
wherein said housing is adapted to receive a plurality of electrical backplane elements associated with respective ones of said insert elements.

24. The structure of claim 23, wherein said guide elements comprise raised element pairs.

25. The structure of claim 23, wherein said guide elements comprise a plurality of raised dowels arranged in an array.

26. The structure of claim 23, wherein said guide elements comprise a plurality of depressed elongated slots formed into side walls of said structure.

27. The structure of claim 23, wherein said guide elements comprise a plurality of mechanical fasteners.

28. The structure of claim 23, wherein said structure is further adapted to mate with parent device.

29. A method of configuring a user-configurable electronics assembly having a housing adapted to receive a plurality of insert elements, said insert elements each having at least one circuit disposed thereon and a plurality of edge terminals;
selecting the number of insert elements to be used in said assembly;
providing one multi-connector backplane element for each of said selected inserts, said backplane element(s) having a corresponding edge connector;
mating said backplane element(s) to a rear face of said housing; and
disposing said insert element(s) within said housing, said edge terminals mating with said edge connector.

30. A method of reducing the cross-talk associated with a plurality of DSL circuits disposed on a common substrate, comprising providing a plurality of capacitances between selected ones of the tip and ring traces of said circuits, said capacitances being adapted to counteract the effects of cross-talk capacitance created between ones of said tip and ring traces during operation of said circuits.

31. A user-configurable electronics assembly comprising:
a plurality of electronics elements, said at least one assembly having at least one circuit disposed thereon; and
a modular structure having a plurality of separable components, each of said separable components adapted to receive at least one of said electronics elements and retain said at least one element in a substantially fixed position;
said components each further comprising at least one backplane element adapted to electrically communicate with said at least one electronics element, said backplane element having a plurality of ports for electrically communication with other electronic devices;
wherein said assembly is further adapted to accommodate a varying number of different configurations of said separable components and said elements disposed therein according to the configuration desired by the user.
